(19) United States
(12) Patent Application Publication
(10) Pub. No.: US 2025/0363662 A1
(43) Pub. Date: Nov. 27, 2025

(54) IMAGE PROCESSING APPARATUS, IMAGE PROCESSING METHOD, AND COMPUTER READABLE MEDIUM

(71) Applicant: Mitsubishi Electric Corporation, Tokyo (JP)

(72) Inventors: Ryo OKABE, Tokyo (JP); Masahiro DEGUCHI, Tokyo (JP); Osamu TOYAMA, Tokyo (JP); Takehisa MIZUGUCHI, Tokyo (JP)

(73) Assignee: Mitsubishi Electric Corporation, Tokyo (JP)

(21) Appl. No.: 19/290,568

(22) Filed: Aug. 5, 2025

Related U.S. Application Data
(63) Continuation of application No. PCT/JP2023/013484, filed on Mar. 31, 2023.

(51) Int. Cl. G06T 7/73; G05B 19/402

(52) U.S. Cl. CPC G06T 7/73; G05B 19/402; G05B 2219/34013; G05B 2219/39391; G06T 2207/30164

(57) ABSTRACT

An Ethernet processing unit (310) receives a plurality of payload packets that stores a plurality of divided images obtained by dividing a captured image. The Ethernet processing unit (310) and a packet discard unit (311) select from the plurality of payload packets, a payload packet that stores a divided image subject to image processing.

### CROSS REFERENCE TO RELATED APPLICATIONS

This application is a Continuation of PCT International Application No. PCT/JP2023/013484 filed on Mar. 31, 2023, all of which is hereby expressly incorporated by reference into the present application.

### TECHNICAL FIELD

The present disclosure relates to image processing.

### BACKGROUND ART

In Factory Automation (FA), various technologies (position-setting technologies) that use a servomotor to align the position (the control object position) of a position-setting object, such as a workpiece, with a target position have been put into practical use.

As a technique to measure the control object position, there is a technique to measure the control object position by means of image processing of a captured image captured by a camera. In the technique to measure the control object position by means of image processing, as disclosed in Patent Literature 1, the camera captures the position-setting object to include the control object position, for example. Then, an image processing apparatus analyzes the captured image and then the distance between the control object position and the target position is calculated.

### CITATION LIST

### Patent Literature

Patent Literature 1: JP No. 2019-003388 A

### SUMMARY OF INVENTION

### Technical Problem

In conventional position-setting technology by means of image processing, as represented by Patent Literature 1, the function that performs the image processing within the image processing apparatus acquires the entire captured image. Therefore, in the conventional technology, there is a problem in that, when the image processing apparatus receives the captured image, it takes a long time for the function that performs the image processing to acquire the captured image after receiving the capture image.

The present disclosure mainly aims to solve such a problem. More specifically, the present disclosure aims to shorten the time taken for the function that performs the image processing to acquire the captured image after receiving the captured image.

### Solution to Problem

An image processing apparatus according to the present disclosure includes:
a packet reception unit to receive a plurality of payload packets that store a plurality of divided images obtained by dividing a captured image; and
a packet selection unit to select from the plurality of payload packets, a payload packet that stores a divided image subject to image processing.

### Advantageous Effects of Invention

According to the present disclosure, it is possible to shorten the time taken for the function that performs the image processing to acquire the captured image after receiving the captured image.

### BRIEF DESCRIPTION OF DRAWINGS

FIG. 1 is a diagram illustrating an example of a configuration of a position-setting system according to Embodiment 1.

FIG. 2 illustrates a method of sending a captured image according to Embodiment 1.

FIG. 3 is a diagram illustrating an example of a hardware configuration of an image processing apparatus according to Embodiment 1.

FIG. 4 is a diagram illustrating an example of a hardware configuration of a motion controller according to Embodiment 1.

FIG. 5 is a diagram illustrating an example of functional configurations of the image processing apparatus and the motion controller according to Embodiment 1.

FIG. 6 is a diagram illustrating an example of a filter table according to Embodiment 1.

FIG. 7 is a diagram describing a method of deciding a position-setting usage area according to Embodiment 1.

FIG. 8 is a diagram describing a method of deciding a packet subject to being discarded according to Embodiment 1.

FIG. 9 is a flowchart illustrating an example of operation of the position-setting system according to Embodiment 1.

FIG. 10 is a diagram illustrating an example of operation of the image processing apparatus according to Embodiment 1.

FIG. 11 is a flowchart illustrating an example of operation of a pattern detection unit according to Embodiment 1.

FIG. 12 is a flowchart illustrating an example of operation of the motion controller according to Embodiment 1.

### DESCRIPTION OF EMBODIMENTS

Hereinafter, Embodiments will be described with reference to the drawings. In the following description and drawings of the Embodiments, the same reference numerals denote the same or corresponding parts.

### Embodiment 1

### ***Description of Configuration***

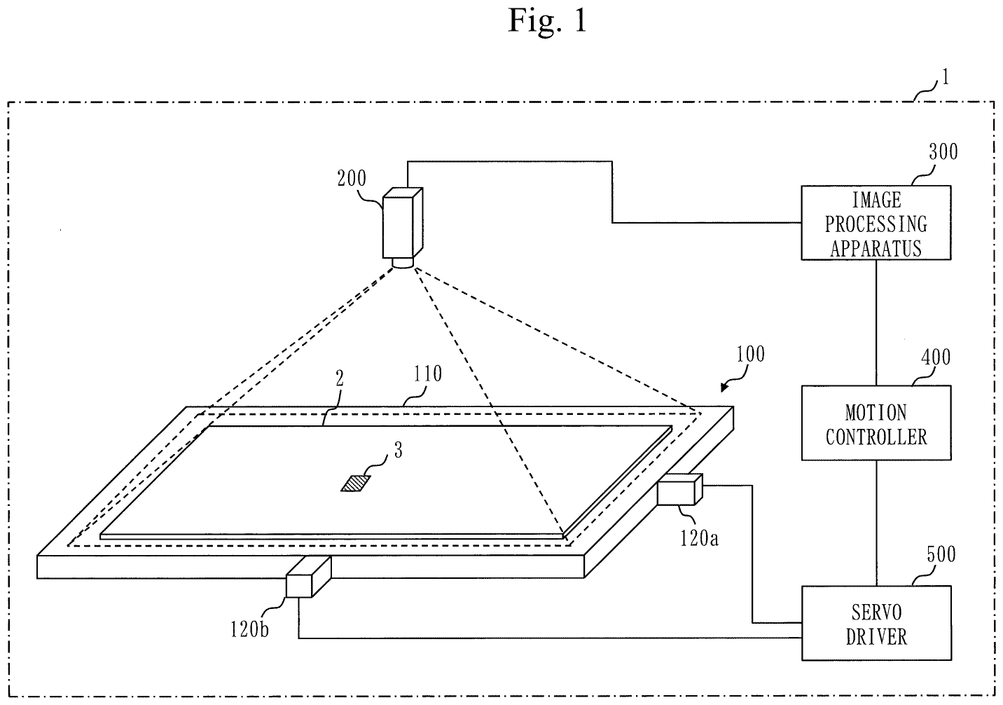

FIG. 1 illustrates an example of a configuration of a position-setting system 1 according to the present embodiment.

In FIG. 1, in the position-setting system 1, position setting of a workpiece 2 is performed by means of image processing.

The position-setting system 1 includes a movement mechanism 100, a camera 200, an image processing apparatus 300, a motion controller 400, and a servo driver 500.

The workpiece 2 is, for example, a printed circuit board. The workpiece 2 has a feature part 3 that is used for the position setting. The feature part 3 is, for example, an installed chip, an unimplemented pattern, a recognition mark, or the like. Further, the feature part 3 may be configured with any combination of these.

Since the workpiece 2 is subject to the position setting by the position-setting system 1, the workpiece 2 is equivalent to a position-setting object. Further, since the workpiece 2 is subject to be captured by the camera 200, the workpiece 2 is equivalent also to a capturing object.

The movement mechanism 100 moves the workpiece 2.

The movement mechanism 100 includes an XY stage 110, a servomotor 120a, and a servomotor 120b.

The servomotor 120a drives the XY stage 110 in the X-axis direction. The servomotor 120b drives the XY stage 110 in the Y-axis direction.

The movement mechanism 100 may include an XYθ stage in place of the XY stage 110.

The camera 200 captures the workpiece 2. Then, the camera 200 sends to the image processing apparatus 300, a captured image obtained by the capturing. In the present embodiment, it is assumed that the camera 200 sends the captured image to the image processing apparatus 300 via Ethernet (registered trademark). Further, in the present embodiment, the camera 200 communicates with the image processing apparatus 300 using the GigE Vision standard. GigE Vision is an interface standard for industrial cameras.

The image processing apparatus 300 receives the captured image from the camera 200. Further, the image processing apparatus 300 performs the image processing on the captured image, and specifies the position of the feature part 3 on the workpiece 2. Then, the image processing apparatus 300 sets the position of the workpiece 2 by specifying the position of the feature part 3.

An operation procedure of the image processing apparatus 300 is equivalent to an image processing method. Further, a program that implements operation of the image processing apparatus 300 is equivalent to an image processing program.

The motion controller 400 generates a movement command to bring the position of the workpiece 2 closer to a target position based on the position of the feature part 3 specified by the image processing apparatus 300. Then, the motion controller 400 outputs the generated movement command to the servo driver 500.

The servo driver 500 performs feedback control of the servomotor 120a and the servomotor 120b based on the movement command received from the motion controller 400.

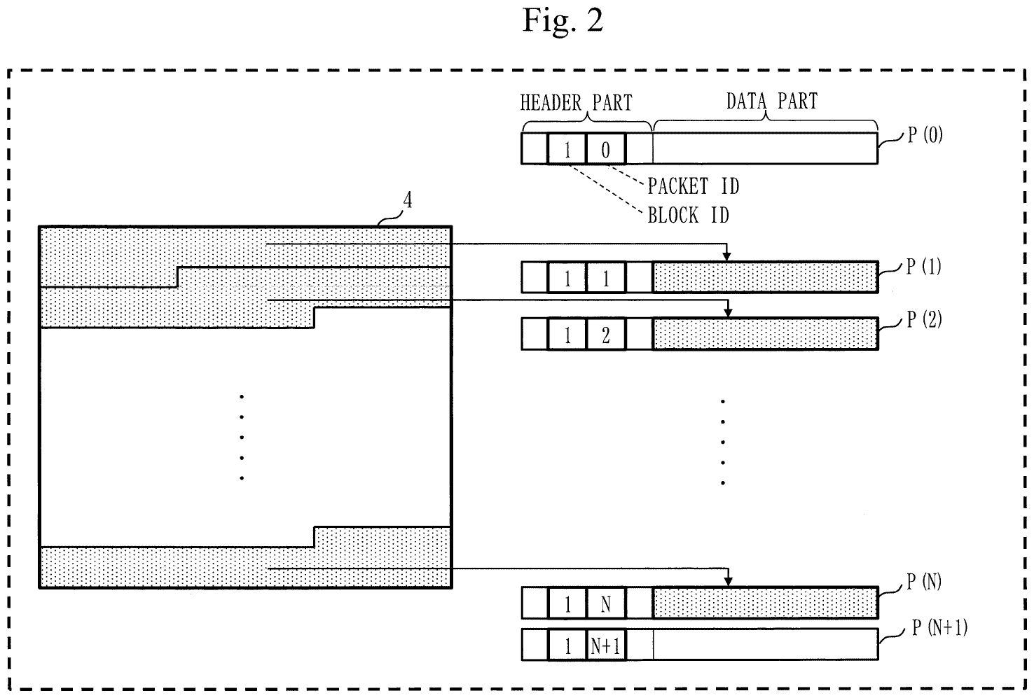

FIG. 2 illustrates a method by which the camera 200 divides the captured image into a plurality of packets and sends them.

A captured image 4 of the workpiece 2, captured by the camera 200, is divided into a plurality of divided images in raster scan format. The size of each of the divided images is consistent. Then, the plurality of divided images are stored in a plurality of payload packets P (1)-P (N). Then, a leader packet P (0), one or more payload packets P (1)-P (N), and a trailer packet P (N+1) are sent in sequence. The leader packet P (0) is the first packet for the captured image 4. Each of the payload packets P (1)-P (N) stores a divided image. The trailer packet P (N+1) is the last packet for the captured image 4. Neither the leader packet P (0) nor the trailer packet P (N+1) stores a divided image.

A block ID, which is a continuous number of the captured image 4, and a packet ID, which is a continuous number of a packet within the captured image 4, are assigned to the leader packet P (0), each of the payload packets P (1)-P (N), and the trailer packet P (N+1). The block ID is an integer value that is incremented for each captured image 4.

In FIG. 2, the camera 200 assigns “1” as the block ID to the captured image 4. The packet ID is an integer value that is incremented for each packet. The packet ID is initialized with “0” for each captured image 4. In FIG. 2, the camera 200 assigns “0” through “N+1” as the packet ID to the plurality of packets in sequence.

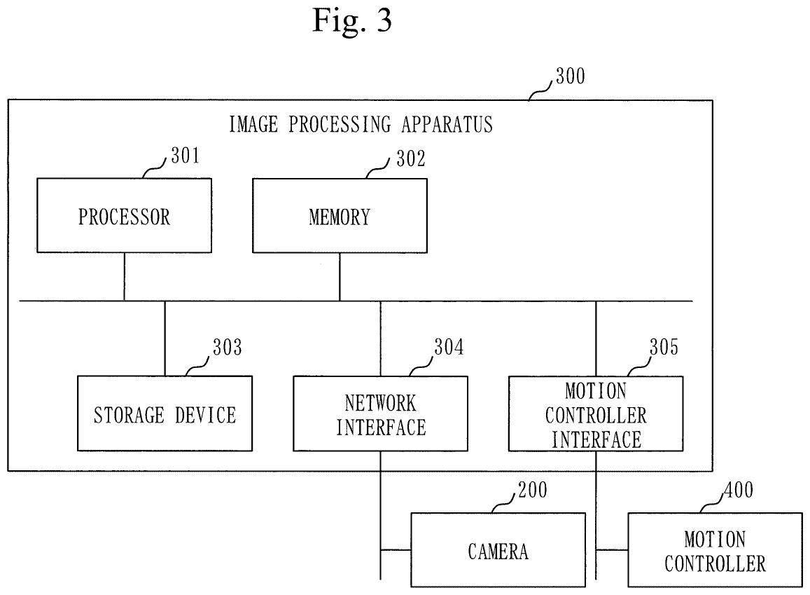

FIG. 3 illustrates an example of a hardware configuration of the image processing apparatus 300.

The image processing apparatus 300 is a computer.

As illustrated in FIG. 3, the image processing apparatus 300 includes a processor 301, a memory 302, a storage device 303, a network interface 304, and a motion controller interface 305.

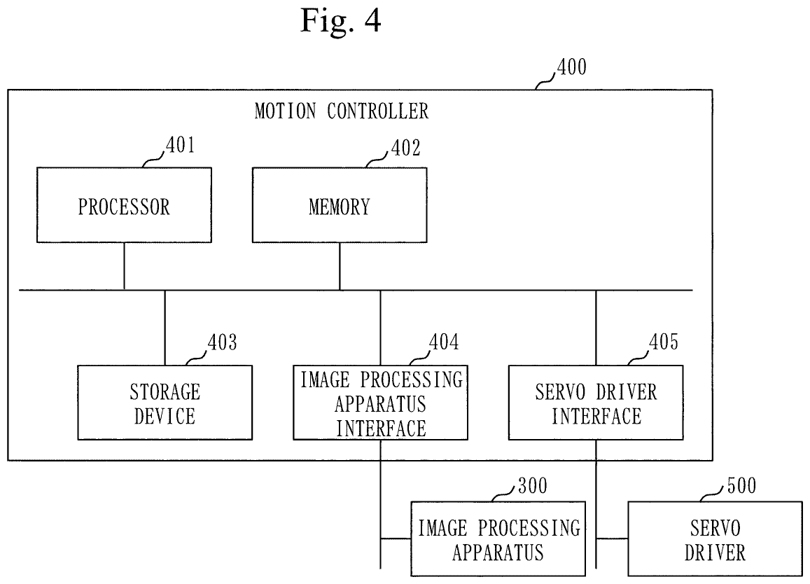

FIG. 4 illustrates an example of a hardware configuration of the motion controller 400.

The motion controller 400 is a computer.

As illustrated in FIG. 4, the motion controller 400 includes a processor 401, a memory 402, a storage device 403, an image processing apparatus interface 404, and a servo driver interface 405.

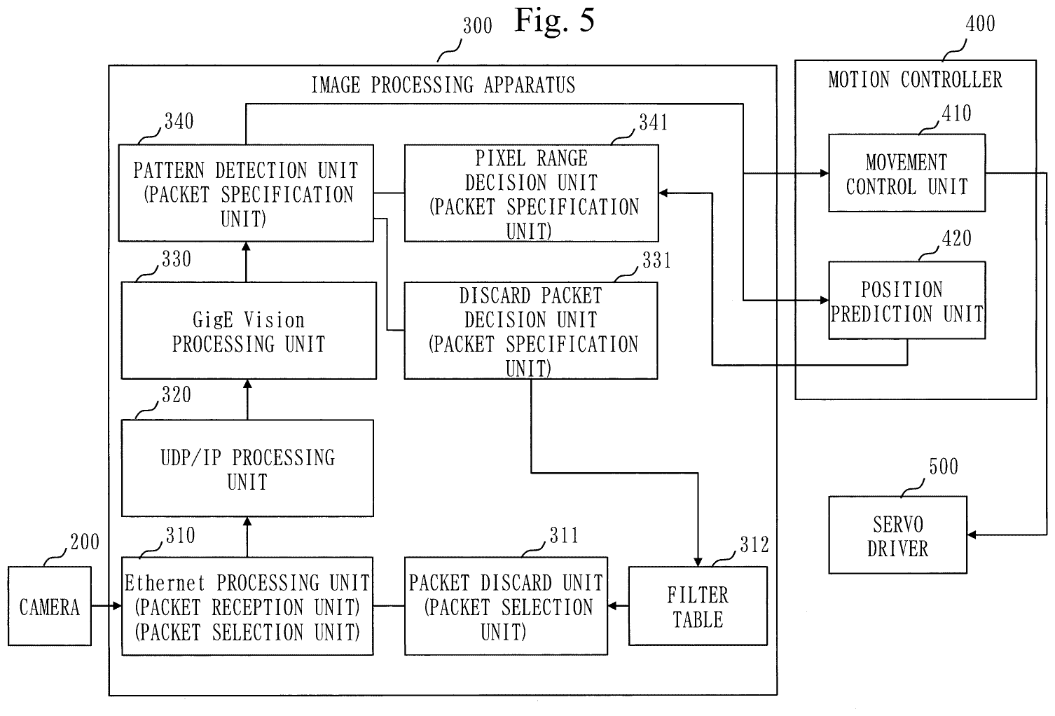

FIG. 5 illustrates an example of functional configurations of the image processing apparatus 300 and the motion controller 400.

An Ethernet processing unit 310 receives a divided image sent by the camera 200 in the form of an Ethernet (registered trademark) frame. The Ethernet processing unit 310 inputs to the UDP/IP processing unit 320, an Internet Protocol (IP) packet which is a payload.

More specifically, the Ethernet processing unit 310 selects from the payload packets P (1)-P (N) illustrated in FIG. 2, a payload packet that stores a divided image subject to the image processing for position setting of the workpiece 2. Then, the Ethernet processing unit 310 transfers the selected payload packet to the UDP/IP processing unit 320. The Ethernet processing unit 310 discards payload packets other than the selected payload packet.

The Ethernet processing unit 310 is equivalent to a packet reception unit. Further, the Ethernet processing unit 310 is equivalent to a packet selection unit, together with a packet discard unit 311 to be described below. Further, a process performed by the Ethernet processing unit 310 is equivalent to a packet reception process. Further, a process performed by the Ethernet processing unit 310 is equivalent to a packet selection process, together with a process performed by the packet discard unit 311.

The UDP/IP processing unit 320 extracts a User Datagram Protocol (UDP) packet from the input IP packet. Then, the UDP/IP processing unit 320 inputs a GigE Vision packet, which is a payload of the UDP packet, to a GigE Vision processing unit 330.

The GigE Vision processing unit 330 constructs from one or more GigE Vision packets, a partial image which is a part of the captured image 4. The partial image constructed by the GigE Vision processing unit 330 is an image of a position-setting usage area to be described below. The GigE Vision processing unit 330 inputs the partial image to a pattern detection unit 340.

The GigE Vision processing unit 330 determines which captured image 4 the acquired GigE Vision packet constitutes, based on the block ID illustrated in FIG. 2. The GigE Vision processing unit 330 constructs the partial image from the payload packets according to the order indicated by the packet ID illustrated in FIG. 2.

It is assumed that the size of a single GigE Vision packet is a size that fits within a single UDP packet. It is assumed that the size of the single UDP packet is a size that fits within a single IP packet. It is assumed that the size of the single IP packet is a size that fits within a single Ethernet frame. A jumbo frame may be used to meet these conditions.

The pattern detection unit 340 performs the image processing on the partial image input from the GigE Vision processing unit 330. Then, the pattern detection unit 340 specifies the position of the feature part 3 on the workpiece 2.

The pattern detection unit 340 specifies the position of the feature part 3 by means of pixel unit detection processing through template matching, for example. Instead of or in addition to the pixel unit detection processing, the pattern detection unit 340 may perform subpixel position estimation processing. Then, the pattern detection unit 340 outputs a result (the position of a feature part) of the image processing to the motion controller 400.

The pattern detection unit 340 is equivalent to a packet specification unit, together with a pixel range decision unit 341 and a discard packet decision unit 331 to be described below. Further, a process performed by the pattern detection unit 340 is equivalent to a packet specification process, together with a process performed by the pixel range decision unit 341 and the discard packet decision unit 331 to be described below.

The packet discard unit 311 refers to a filter table 312 to decide whether to discard the payload packet received by the Ethernet processing unit 310, or to input the payload packet received by the Ethernet processing unit 310 to the UDP/IP processing unit 320.

As described above, the packet discard unit 311 is equivalent to the packet selection unit, together with the Ethernet processing unit 310. Further, the process performed by the packet discard unit 311 is equivalent to the packet selection process, together with the process performed by the Ethernet processing unit 310.

The pixel range decision unit 341 decides an image area (hereafter referred to as the position-setting usage area) used for the position setting in a future captured image 4 to be captured at a future capturing timing. The pixel range decision unit 341 decides the position-setting usage area based on the position of the feature part 3 at the future capturing timing, predicted by a position prediction unit 420 to be described below.

Each of the plurality of divided images that form the position-setting usage area is referred to as a position-setting divided image. The GigE Vision processing unit 330 described above constructs the partial image that shows the position-setting usage area by combining the plurality of position-setting divided images. The details on the position-setting usage area will be described below.

As described above, the pixel range decision unit 341 is equivalent to the packet specification unit, together with the pattern detection unit 340 and the discard packet decision unit 331. Further, the process performed by the pixel range decision unit 341 is equivalent to the packet specification process, together with the process performed by the pattern detection unit 340 and the discard packet decision unit 331.

The discard packet decision unit 331 decides which payload packet is subject to being discarded. More specifically, the discard packet decision unit 331 calculates the block ID corresponding to the future captured image 4. Further, the discard packet decision unit 331 calculates the packet ID of a payload packet that does not store a position-setting divided image among the payload packets for the future captured image 4, based on the position-setting usage area in the future captured image 4. Then, the discard packet decision unit 331 registers a calculation result in the filter table 312.

In other words, the discard packet decision unit 331 specifies a payload packet that stores a position-setting divided image prior to the selection of a payload packet for the future captured image 4 by the Ethernet processing unit 310.

As described above, the discard packet decision unit 331 is equivalent to the packet specification unit, together with the pattern detection unit 340 and the pixel range decision unit 341. Further, the process performed by the discard packet decision unit 331 is equivalent to the packet specification process, together with the process performed by the pattern detection unit 340 and the pixel range decision unit 341.

Functions of the Ethernet processing unit 310, the UDP/IP processing unit 320, and the like illustrated in FIG. 5 are implemented by, for example, programs. The storage device 303 illustrated in FIG. 3 stores the programs that implement the functions of the Ethernet processing unit 310, the UDP/IP processing unit 320, and the like.

These programs are loaded from the storage device 303 to the memory 302. Then, the processor 301 executes these programs to perform operation of the Ethernet processing unit 310, the UDP/IP processing unit 320, and the like.

In the motion controller 400, a movement control unit 410 generates a movement command to bring the position of the workpiece 2 closer to a target position. More specifically, the movement control unit 410 generates the movement command based on the position of the feature part 3 specified by the image processing apparatus 300.

Then, the movement control unit 410 outputs the generated movement command to the servo driver 500.

The position prediction unit 420 predicts the position of the feature part 3 at the future capturing timing. More specifically, the position prediction unit 420 predicts the position of the feature part 3 based on the past and current positions of the feature part 3 specified by the pattern detection unit 340.

Then, the position prediction unit 420 notifies the pixel range decision unit 341 of the predicted position of the feature part 3.

Functions of the movement control unit 410 and position prediction unit 420 illustrated in FIG. 5 are implemented by, for example, programs. The storage device 403 illustrated in FIG. 4 stores the programs that implement the functions of the movement control unit 410 and position prediction unit 420.

These programs are loaded from the storage device 403 to the memory 402. Then, the processor 401 executes these programs to perform operation of the movement control unit 410 and position prediction unit 420.

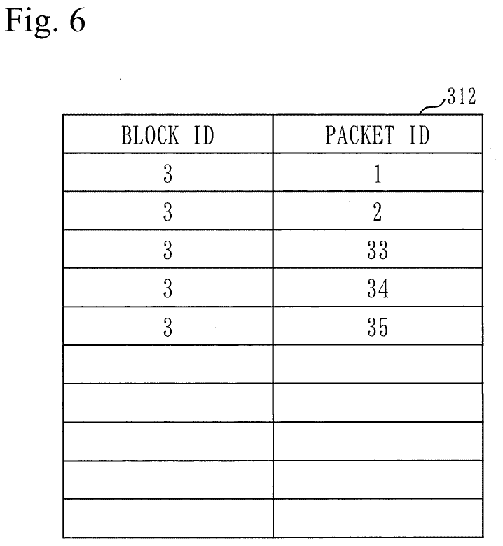

FIG. 6 illustrates an example of the filter table 312.

The filter table 312 is a table that is generated on the memory 302. The filter table 312 holds information for specifying a payload packet subject to being discarded by the Ethernet processing unit 310 in the future.

In the filter table 312 of FIG. 6, pairs of the block ID and the packet ID are registered as the information for specifying a payload packet subject to being discarded in the future. FIG. 6 indicates the packet ID of the payload packet subject to being discarded, that stores the divided image of the captured image 4 with the block ID of “3”. Specifically, the payload packet with the packet ID of “1” is subject to being discarded. Further, the payload packet with the packet ID of “2” is subject to being discarded. Furthermore, the payload packet with the packet ID of “33” is subject to being discarded. In addition, the payload packet with the packet ID of “34” is subject to being discarded. In addition, the payload packet with the packet ID of “35” is subject to being discarded.

FIG. 6 illustrates an example of the filter table 312 that is configured by a ring buffer. The filter table 312 may be configured by a hash set or a hash map whose key is a pair of the block ID and the packet ID.

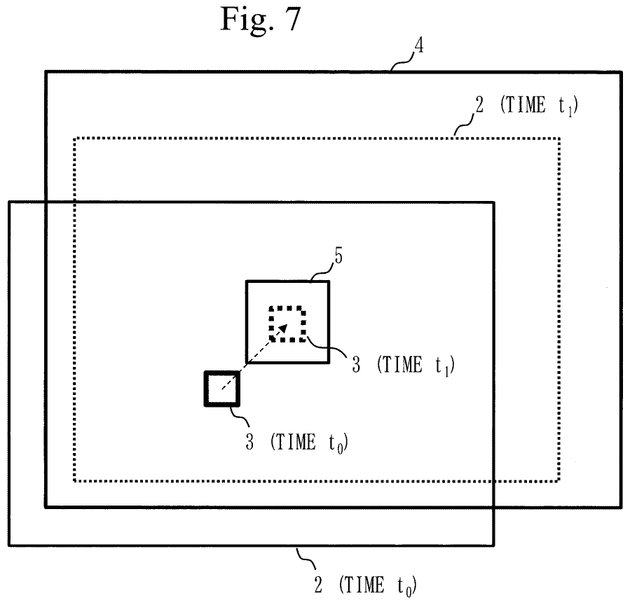

FIG. 7 illustrates a method by which the position prediction unit 420 and the pixel range decision unit 341 decide a position-setting usage area 5.

First, the position prediction unit 420 predicts the position of the feature part 3 at a time t₁ (t₁=t₀+Δt) which is the future capturing timing, at a time t₀.

More specifically, the position prediction unit 420 predicts the position of the feature part 3 at the time t₁ based on the position of the feature part 3 at the time to and the predicted movement amount (the movement amount of the workpiece 2 from the time t₀ to the time t₁) of the feature part 3 calculated from the movement command generated by the movement control unit 410 at the time to.

In addition to these, the position prediction unit 420 may use a damped oscillation model generated from past position information on the feature part 3 to predict the position of the feature part 3.

Next, the pixel range decision unit 341 decides the entire view of the feature part 3 and the rectangular area surrounding the feature part 3 in the future captured image 4 to be captured at the time t₁, as the position-setting usage area 5.

A divided image that shows at least a part of the feature part 3 is referred to as a feature divided image. In the present embodiment, an image that shows the entire view of the feature part 3 is configured by a combination of one or more feature divided images. Further, an image that shows at least a part of the rectangular area surrounding the feature part 3 is referred to as a surrounding divided image. In the present embodiment, an image that shows the entire view of the surrounding rectangular area is configured by a combination of one or more surrounding divided images.

When a divided image shows at least a part of the feature part 3 and at least a part of the surrounding rectangular area, the divided image is both a feature divided image and a surrounding divided image.

As described above, each of the plurality of divided images that form the position-setting usage area 5 is referred to as a position-setting divided image. To simplify the explanation, in the present embodiment, each of the position-setting divided images is either a feature divided image or a surrounding divided image. In actual operation, the position-setting divided image may be a divided image described above that is both a feature divided image and a surrounding divided image.

The size of the position-setting usage area 5 may be either fixed or variable, as long as it is the size that can fully include the entire view of the feature part 3.

As an example of the variable size, when there is a possibility that the prediction accuracy of the position of the feature part 3 decreases, it is conceivable to increase the size of the position-setting usage area 5. When it is predicted that the movement distance of the workpiece 2 is large from the time t₀ to the time t₁, it is conceivable to increase the size of the position-setting usage area 5, for example. Further, when it is predicted that the oscillation width of the workpiece 2 is large from the time t₀ to the time t₁, it is conceivable to increase the size of the position-setting usage area 5.

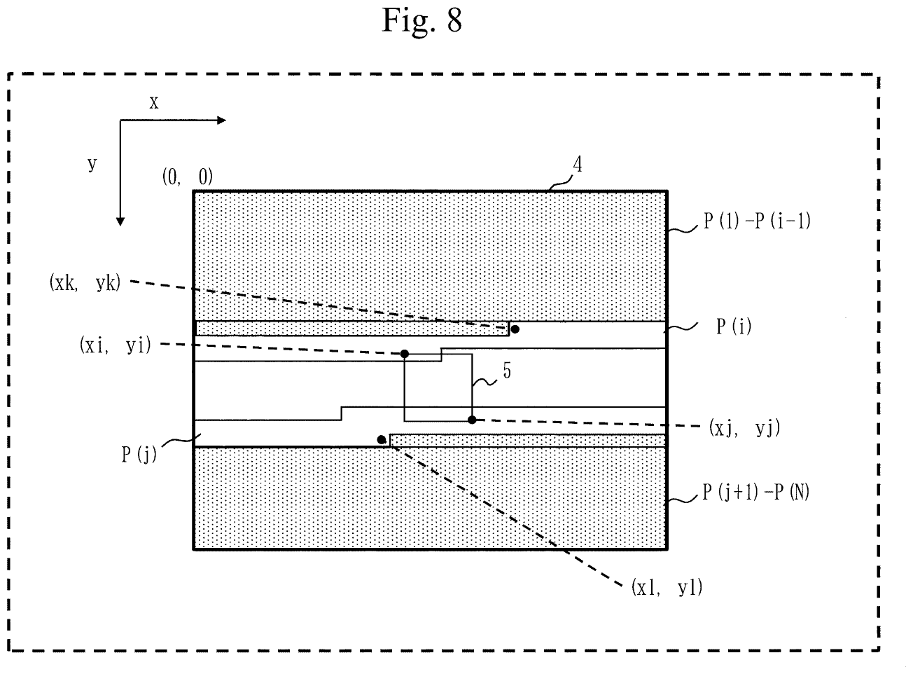

FIG. 8 describes a method by which the discard packet decision unit 331 decides a packet subject to being discarded. That is, FIG. 8 illustrates a method by which the discard packet decision unit 331 calculates the packet ID of a payload packet that stores a divided image that does not correspond to a position-setting divided image. In other words, FIG. 8 illustrates a method by which the discard packet decision unit 331 calculates the packet ID of a payload packet that stores a position-setting divided image.

Here, the current time is denoted as to [seconds] and the future capturing timing is denoted as t₁ (t₁=t₀+Δt) [seconds]. Further, the frame rate is denoted as f[fps] and the block ID of the captured image 4 captured at the current time t₀ is denoted as b₀.

The block ID of a future captured image 4 to be captured at the future time t₁ is calculated by b₁=b₀+f[fps]×Δt [seconds]. In the position setting using the future captured image 4, the leader packet, the trailer packet, and all payload packets that store divided images (position-setting divided images) that correspond to the position-setting usage area 5 are subject to the image processing at the pattern detection unit 340. In other words, a payload packet that stores a divided image that does not correspond to the position-setting usage area 5 is subject to being discarded.

Here, the head coordinates and the trail coordinates obtained by raster scanning of the position-setting usage area 5 are denoted as (xi, yi) and (xj, yj), respectively. Further, the packet IDs of the payload packets that store the divide images of the future captured image 4 are denoted as P (1) through P (N). Then, the packet ID of the payload packet that stores the divided image that includes the head coordinates of the position-setting usage area 5 is denoted as P (i), and the packet ID of the payload packet that stores the divided image that includes the tail coordinates of the position-setting usage area 5 is denoted as P (j). In this case, the payload packets with the packet IDs P (1) through P (i−1) and the payload packets with the packet IDs P (j+1) through P (N) are discarded.

### ***Description of Operation***

Next, an example of operation of the position-setting system 1 according to the present embodiment will be described.

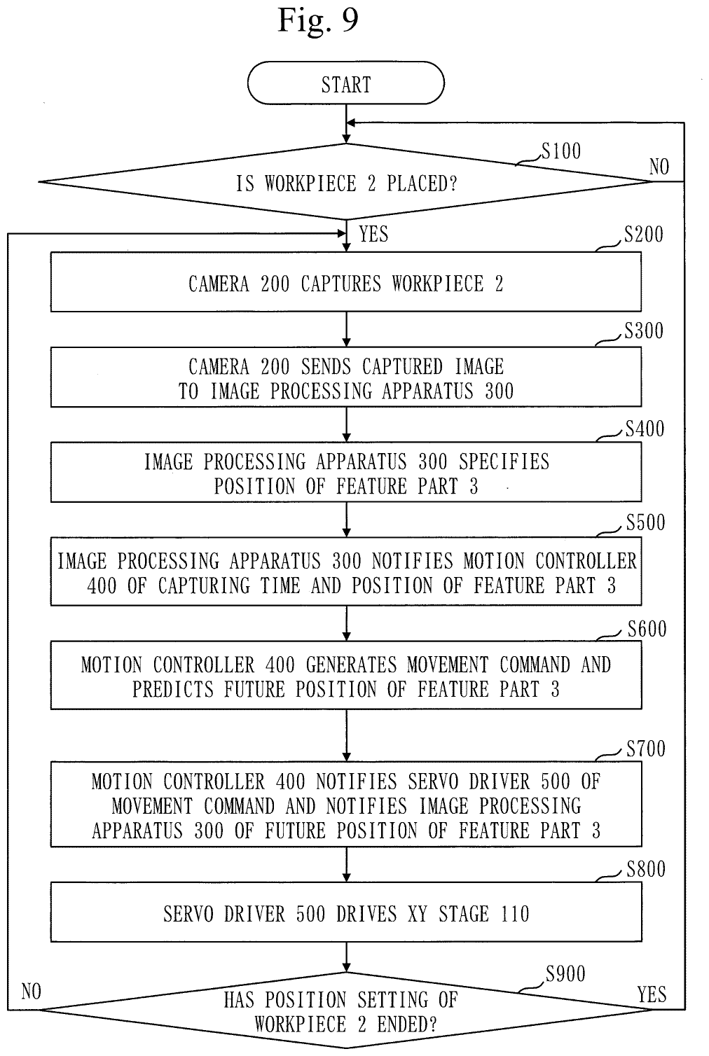

FIG. 9 illustrates an example of the position-setting system 1 to perform the position setting of the workpiece 2 by means of the image processing.

First, in step S100, when the workpiece 2 is newly placed, the process proceeds to step S200.

In step S200, the camera 200 captures the workpiece 2 placed on the XY stage 110 and records a capturing time. The camera 200 executes the capturing of the workpiece 2 in step S200 for each capturing cycle.

Next, in step S300, the camera 200 sends to the image processing apparatus 300, the captured image 4 and the capturing time obtained in step S200. The camera 200 communicates with the image processing apparatus 300 using the GigE Vision standard, for example. The capturing time is stored in the leader packet. The plurality of divided images divided from the captured image 4 are stored in one or more payload packets. Then, as illustrated in FIG. 2, the leader packet, the payload packets, and the trailer packet are sent from the camera 200 to the image processing apparatus 300. The camera 200 completes the sending of step S300 by the start time of the next capturing cycle.

In step S400, the image processing apparatus 300 receives the leader packet, the payload packets, and the trailer packet sent from the camera 200, and acquires the divided images and their capturing time. Then, the image processing apparatus 300 performs the image processing, and specifies the current position of the feature part 3 on the workpiece 2.

In step S500, the image processing apparatus 300 notifies the movement control unit 410 and the position prediction unit 420 of the motion controller 400 about the capturing time and the current position of the feature part 3 specified in step S400.

The details of the processing of the image processing apparatus 300 described in step S400 and step S500 will be described below.

In step S600, the movement control unit 410 generates a movement command to bring the position of the workpiece 2 closer to a target position based on the current position of the feature part 3 specified by the image processing apparatus 300. In addition, the position prediction unit 420 predicts the position of the feature part 3 at the future capturing timing.

In step S700, the movement control unit 410 of the motion controller 400 notifies the servo driver 500 of the movement command generated in step S600. In addition, the position prediction unit 420 of the motion controller 400 notifies the pixel range decision unit 341 of the image processing apparatus 300 about the predicted position of the feature part 3 calculated in step S600.

The details of the processing of the motion controller 400 described in steps S600 and S700 will be described below.

In step S800, the servo driver 500 performs feedback control on the servomotor 120a and the servomotor 120b to approach the movement amount of the XY stage 110 to the movement command. Then, the servomotor 120a and the servomotor 120b drive the XY stage 110 to alter the position of the workpiece 2.

As indicated in step S900, steps S200 to S800 are repeated until the workpiece 2 moves to the target position.

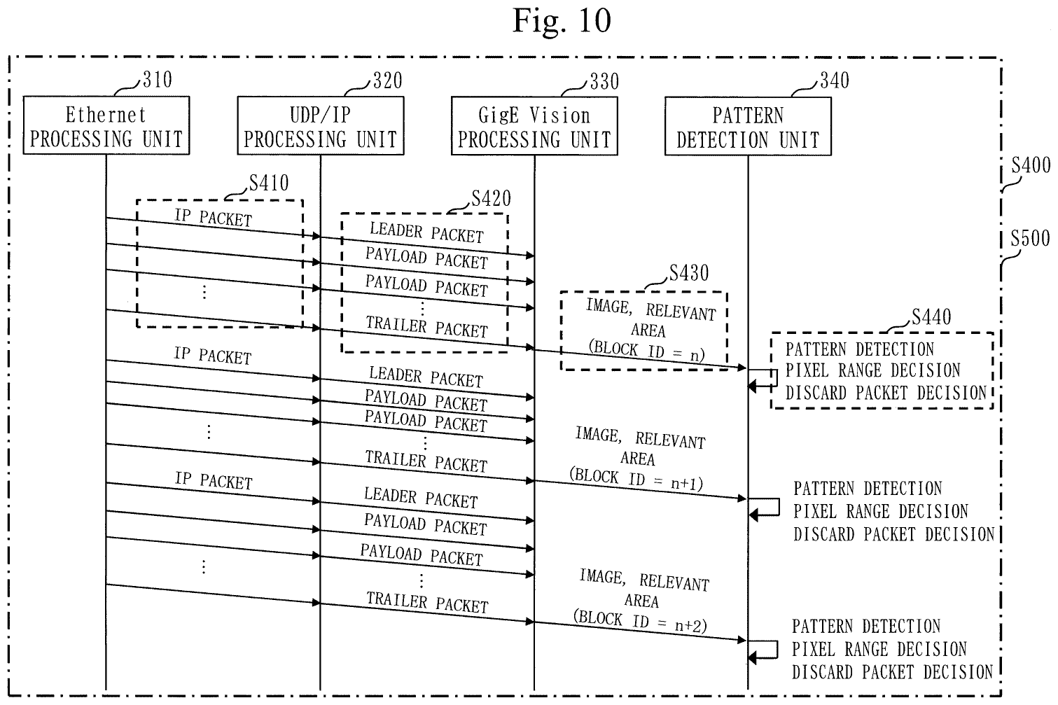

FIG. 10 describes the detailed processing of the image processing apparatus 300 in steps S400 and S500.

The image processing apparatus 300 executes the processes of steps S410 to S440 in FIG. 10 for each image processing cycle. The length of the image processing cycle is the same as that of the capturing cycle. The start time of the image processing cycle is not necessary to be the same as the start time of the capturing cycle.

In FIG. 10, the Ethernet processing unit 310 and the UDP/IP processing unit 320, and the GigE Vision processing unit 330 and the pattern detection unit 340 operate on separate Central Processing Unit (CPU) cores. Therefore, the Ethernet processing unit 310 and the UDP/IP processing unit 320, and the GigE Vision processing unit 330 and the pattern detection unit 340 operate in parallel.

More specifically, while the GigE Vision processing unit 330 and the pattern detection unit 340 processes the captured image 4 with the block ID=n, the Ethernet processing unit 310 and the UDP/IP processing unit 320 perform the reception process of a packet corresponding to the captured image 4 with the block ID=n+1.

First, in step S410, the Ethernet processing unit 310 selects from Ethernet frames that have arrived at the network interface 304, an Ethernet frame from which an IP packet needs to be input to the UDP/IP processing unit 320.

More specifically, the Ethernet processing unit 310 uses the packet discard unit 311 to determine whether or not a received Ethernet frame needs to be discarded.

The packet discard unit 311 refers to the header of the GigE Vision protocol of the received Ethernet frame. Then, the packet discard unit 311 determines whether or not the set of the block ID and the packet ID held by the Ethernet frame is consistent with the set of the block ID and the packet ID registered in the filter table 312.

When the set of the block ID and the packet ID of the Ethernet frame is consistent with the set of the block ID and the packet ID in the filter table 312, the packet discard unit 311 determines that the Ethernet frame needs to be discarded. The Ethernet processing unit 310 discards the Ethernet frame determined by the packet discard unit 311 to be discarded without inputting it to the UDP/IP processing unit 320. After the Ethernet frame has been discarded, the packet discard unit 311 deletes from the filter table 312, the set of the block ID and the packet ID of the Ethernet frame.

On the other hand, when the packet discard unit 311 does not determine that the Ethernet frame needs to be discarded, the Ethernet processing unit 310 inputs an IP packet of the payload of the Ethernet frame to the UDP/IP processing unit 320. That is, the Ethernet processing unit 310 and the packet discard unit 311 select from the plurality of IP packets, an IP packet subject to the image processing.

Next, in step S420, the UDP/IP processing unit 320 extracts a UDP packet from the input IP packet. Furthermore, the UDP/IP processing unit 320 extracts a GigE Vision packet from the payload of the extracted UDP packet.

Then, the UDP/IP processing unit 320 inputs the extracted GigE Vision packet to the GigE Vision processing unit 330. The GigE Vision packet that is input to the GigE Vision processing unit 330 is either a leader packet, a payload packet, or a trailer packet.

In step S430, the GigE Vision processing unit 330 constructs a partial image from the leader packet, one or more payload packets, and the trailer packet. The partial image constructed by the GigE Vision processing unit 330 is an image that shows the position-setting usage area 5.

The GigE Vision processing unit 330 constructs the partial image by combining the divided images (position-setting divide images) stored in all payload packets that have the common block ID according to the order indicated by the packet ID. When a part of the payload packets has been discarded in step S410, the GigE Vision processing unit 330 skips to store the divided image in a memory region corresponding to the discarded payload packets during the construction of the partial image. In this case, the divided image is not stored in the memory region. Therefore, in the memory region, a value (an initial value, an indefinite value, or the like) that is originally stored in the memory region is maintained.

Once the GigE Vision processing unit 330 has completed the construction of the partial image upon receiving the trailer packet, the GigE Vision processing unit 330 inputs to the pattern detection unit 340, the partial image, the capturing time obtained from the leader packet, and the head coordinates and tail coordinates of the partial image obtained by raster scanning.

The GigE Vision processing unit 330 inputs to the pattern detection unit 340, the coordinates of the first pixel of the head divided image of the partial image, as the head coordinates of the partial image. Further, the GigE Vision processing unit 330 inputs to the pattern detection unit 340, the coordinates of the last pixel of the tail divided image of the partial image, as the tail coordinates of the partial image.

The head coordinates of the partial image are described using FIG. 8, and are the coordinates (xk, yk) of the first pixel of the divided image stored in the payload packet whose packet ID is P (i). The tail coordinates of the partial image are described using FIG. 8, and are the coordinates (xl, yl) of the last pixel of the divided image stored in the payload packet whose packet ID is P (j).

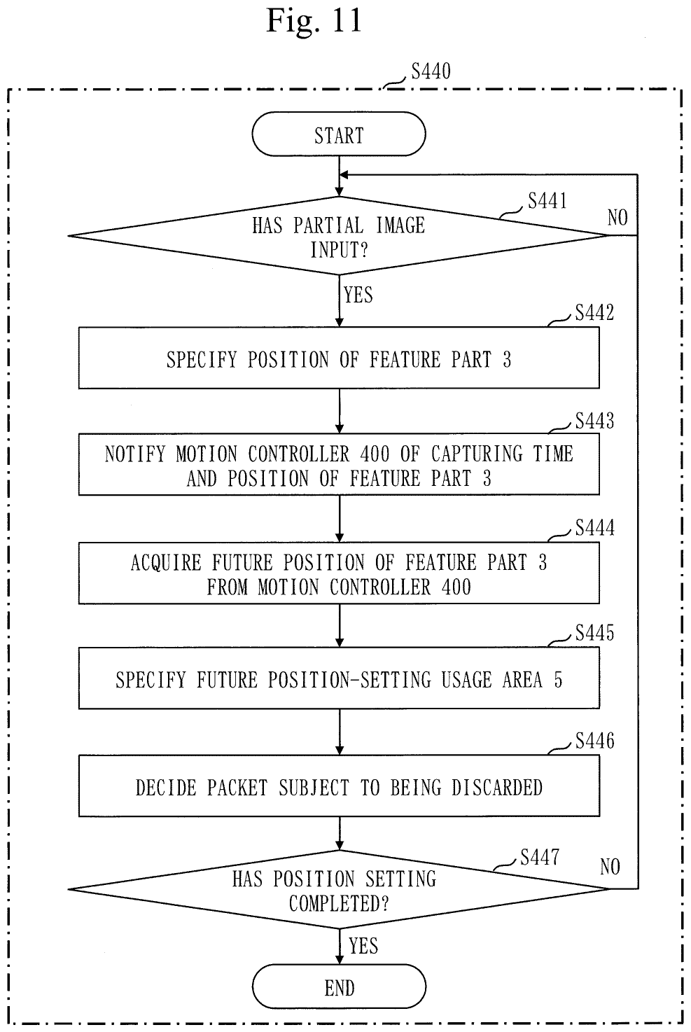

FIG. 11 illustrates an example of operation of the pattern detection unit 340 in step S440.

In step S441, the GigE Vision processing unit 330 inputs to the pattern detection unit 340, a partial image, the capturing time of the partial image, and the head coordinates and the tail coordinates of the partial image.

Next, in step S442, the pattern detection unit 340 performs the image processing on the partial image to specify the current position of the feature part 3 on the workpiece 2. In order to perform the image processing efficiently, the pattern detection unit 340 may perform the image processing also on a part of the area outside the partial image. Further, the pattern detection unit 340 may perform the image processing with padding around the partial image.

Next, in step S443, the pattern detection unit 340 notifies the movement control unit 410 and the position prediction unit 420 of the motion controller 400 about the position of a feature part 3 and the capturing time of the partial image which has been used to specify the position of the feature part 3.

Then, in step S444, the pixel range decision unit 341 executed by the pattern detection unit 340 acquires from the position prediction unit 420, the predicted position of the feature part 3 in the future captured image 4. At this time, the pixel range decision unit 341 may obtain information for specifying the future captured image 4. The pixel range decision unit 341 obtains information indicating a difference Δt between the capturing time of the current captured image 4 and the capturing time of the future captured image 4, as the information for specifying the future captured image 4, for example. Further, the pixel range decision unit 341 may obtain information indicating a difference N between the block ID of the current captured image 4 and the block ID of the future captured image 4, as the information for specifying the future captured image 4.

In the example of FIG. 10, while the GigE Vision processing unit 330 and the pattern detection unit 340 process the partial image of the captured image 4 with the block ID=n, the Ethernet processing unit 310 and the UDP/IP processing unit 320 have already started the reception process of the packets that store the captured image 4 with the block ID=n+1.

Therefore, in the example of FIG. 10, the position prediction unit 420 calculates from the partial image of the captured image 4 with the block ID=n, the predicted position of the feature part 3 in the captured image 4 with the block ID=n+2. That is, the difference between the block ID of the current captured image 4 and the block ID of the future captured image 4 is 2.

Next, in step S445, the pixel range decision unit 341 decides the position-setting usage area 5 in the future captured image 4 based on the predicted position of the feature part 3 obtained in step S444. The method of deciding the position-setting usage area 5 is as described using FIG. 7.

The captured image 4 with the block ID=n described above corresponds to the captured image 4 at the time to in FIG. 7, and the captured image 4 with the block ID=n+2 described above corresponds to the captured image 4 at the time t₁ in FIG. 7.

In step S446, the discard packet decision unit 331 executed by the pattern detection unit 340 decides a packet subject to being discarded. Specifically, the discard packet decision unit 331 calculates the block ID corresponding to the future captured image 4. Further, the discard packet decision unit 331 calculates the packet ID of a payload packet that does not store the position-setting divided image among the payload packets for the future captured image 4, based on the position-setting usage area 5 in the future captured image 4. Then, the discard packet decision unit 331 registers a calculation result in the filter table 312.

The method of calculating the block ID and the packet ID is as described using FIG. 8. Further, the registration contents in the filter table 312 are as described using FIG. 6.

As indicated in step S447, steps S441 to S446 are repeated until the workpiece 2 moves to the target position.

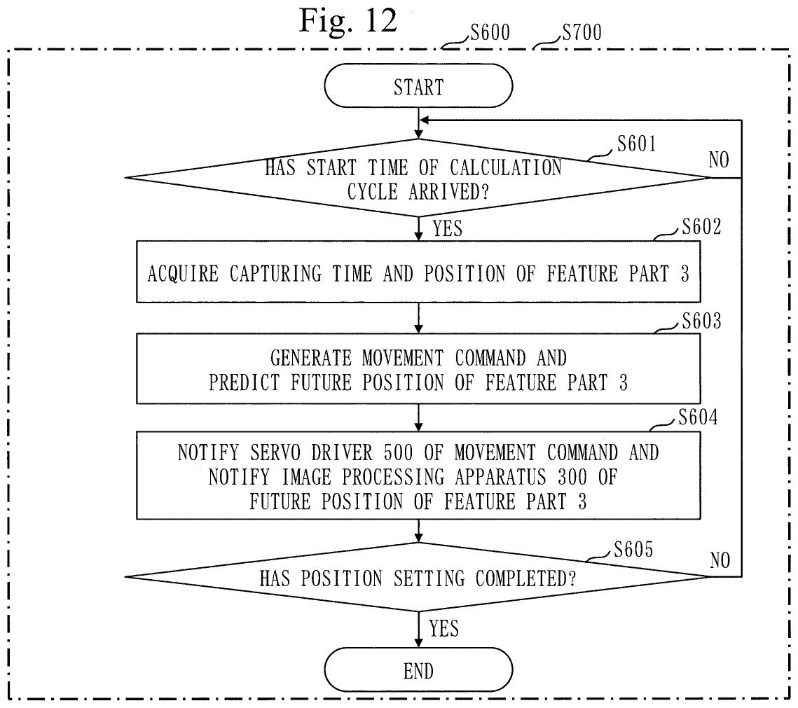

FIG. 12 illustrates an example of operation of the motion controller 400 in steps S600 and S700.

The motion controller 400 executes steps S601 to S604 in FIG. 12 for each calculation cycle.

When the start time of the calculation cycle arrives in step S601, the movement control unit 410 and the position prediction unit 420 obtain, in step S602, the position of a feature part 3 specified by the image processing apparatus 300, and the capturing time of the captured image 4 which has been used to specify the position of the feature part 3.

In step S603, the movement control unit 410 generates the movement command to bring the position of the workpiece 2 closer to the target position based on the position of the feature part 3 specified by the image processing apparatus 300.

Further, the position prediction unit 420 predicts the position of the feature part 3 at the future capturing timing.

The method of the prediction is as described using FIG. 7.

Here, the current capturing time is denoted as t₀ [seconds], the future capturing timing is denoted as t₁ (t₀+Δt) [seconds], and the frame rate is denoted as f[fps]. When calculating the predicted position in the captured image 4 N sheets later from the current captured image 4, Δt is represented as Δt[seconds]=1/f×N. Here, the value of N is decided between the image processing apparatus 300 and the motion controller 400 before the start of the position setting, for example. Alternatively, during the position setting, the image processing apparatus 300 may notify the motion controller 400 of the value of N as necessary.

In step S604, the movement control unit 410 of the motion controller 400 notifies the servo driver 500 of the movement command generated in step S603.

Further, the position prediction unit 420 of the motion controller 400 notifies the pixel range decision unit 341 of the image processing apparatus 300 about the predicted position of the feature part 3 calculated in step S603.

When the position prediction unit 420 notifies the pixel range decision unit 341 about the predicted position of the feature part 3, the position prediction unit 420 may also notify the pixel range decision unit 341 of information indicating which future captured image 4 the predicted position corresponds to. As such information, the position prediction unit 420 notifies the pixel range decision unit 341 of, for example, one of the values of Δt, t₀+Δt, and N.

As indicated in step S605, steps S601 to S604 are repeated until the workpiece 2 moves to the target position.

### ***Description of Effect of Embodiment***

In the present embodiment, the position prediction unit 420 predicts the position of the feature part 3 at a future capturing timing. Then, the pixel range decision unit 341 decides the position-setting usage area 5 in the captured image 4 to be captured at the future capturing timing. Further, the discard packet decision unit 331 specifies a future payload packet that is unnecessary for position setting. In addition, the packet discard unit 311 discards the unnecessary payload packet. Therefore, according to the present embodiment, it is possible to shorten the time from when the Ethernet processing unit 310 receives the captured image 4 from the camera 200 connected via a network until when the pattern detection unit 340 acquires the captured image 4. This enables the position setting of a position-setting object at high speed.

In addition, since the amount of data input to the UDP/IP processing unit 320 is reduced, it is possible to reduce the amount of memory used by a socket buffer which is commonly used in a network reception process.

Furthermore, in the present embodiment, the camera 200 captures and sends the entire workpiece 2, and the image processing apparatus 300 discards an unnecessary area of the captured image. Therefore, image processing for the area other than the feature part 3 can be started without delay as needed. This effect cannot be obtained by the conventional method of reducing the amount of transmission data by the camera 200 capturing only a part of the workpiece 2. Further, this effect cannot be obtained by the conventional method of reducing the amount of transmission data by the camera 200 sending only a part (ROI: Region Of Interest) of the captured image.

In the present embodiment, although the image processing apparatus 300 and the motion controller 400 are separate devices, the image processing apparatus 300 and the motion controller 400 may be a single device. Thereby, the movement control unit 410 and the position prediction unit 420 can operate on the same memory as the pixel range decision unit 341. This enables the position-setting usage area 5 in the captured image 4 which will be captured at a future capturing timing to be decided at a higher speed.

Further, in the present embodiment, the Ethernet processing unit 310 and the UDP/IP processing unit 320, and the GigE Vision processing unit 330 and the pattern detection unit 340 operate in parallel on separate CPU cores. Instead, these may operate sequentially on a single CPU core. In this case, after the GigE Vision processing unit 330 and the pattern detection unit 340 have completed the processing of the partial image with the block ID=n, the Ethernet processing unit 310 and the UDP/IP processing unit 320 perform the packet reception process for the captured image 4 with the block ID=n+1. Therefore, the position prediction unit 420 calculates from the partial image with the block ID=n, the predicted position of the feature part 3 in the captured image with the block ID=n+1. That is, the difference between the block ID of the current captured image 4 and the block ID of the future captured image 4 is 1.

Further, in the present embodiment, the size of the position-setting usage area 5 may be either variable or fixed. When the size of the position-setting usage area 5 is made variable, the average time taken from when the Ethernet processing unit 310 receives the captured image 4 until when the pattern detection unit 340 acquires the captured image 4 is shortened. On the other hand, fixing the size of the position-setting usage area 5 implies placing an upper limit on the number of packets that are not discarded but processed by the image processing apparatus 300. Therefore, when the size of the position-setting usage area 5 is fixed, the maximum time taken from when the Ethernet processing unit 310 receives the captured image 4 until when the pattern detection unit 340 acquires the captured image 4 is reduced. This has an effect of enabling the capturing cycle to be shortened and realizing more precise position setting.

Further, in the present embodiment, an example has been described in which the Ethernet processing unit 310 selects a payload packet that stores a divided image to be used in the image processing for the position setting. The Ethernet processing unit 310 can be used not only for the purpose of the position setting but also for the purpose of extracting a divided image of the feature part 3 from a series of a plurality of divided images.

That is, the Ethernet processing unit 310 can receive a plurality of payload packets that store a plurality of divided images obtained by dividing a captured image of a capturing object that has the feature part 3, which is not a position-setting object. Then, the Ethernet processing unit 310 can select from the plurality of payload packets, a payload packet that stores a divided image that has the feature part 3, as a payload packet that stores a divided image subject to the image processing.

The procedures described in the present embodiment are examples.

Therefore, it is acceptable to execute only a part of the procedures described in the present embodiment.

Alternatively, it is acceptable to execute a combination of at least a part of the procedures described in the present embodiment and those not described in the present embodiment.

Alternatively, the configurations and procedures described in the present embodiment may be modified as necessary.

### ***Supplementary Description of Hardware Configurations***

Finally, a supplementary description of the hardware configurations of the image processing apparatus 300 and the motion controller 400 will be given.

The processor 301 is an Integrated Circuit (IC) that performs processing.

The processor 301 is a CPU, a Digital Signal Processor (DSP), or the like.

The memory 302 is a Random access Memory (RAM).

The storage device 303 is a Read Only Memory (ROM), a flash memory, a Hard Disk Drive (HDD), or the like.

Each of the network interface 304 and the motion controller interface 305 is an electronic circuit that executes a communication process for data.

Each of the network interface 304 and the motion controller interface 305 is, for example, a communication chip or a Network Interface Card (NIC).

Further, the storage device 303 also stores an Operating System (OS).

Then, at least a part of the OS is executed by the processor 301.

While executing at least the part of the OS, the processor 301 executes programs that implement the functions of the Ethernet processing unit 310, the UDP/IP processing unit 320 and the like.

By the processor 301 executing the OS, task management, memory management, file management, communication control, and the like are performed.

Further, at least one of information, data, a signal value, and a variable value that indicate results of processes of the Ethernet processing unit 310, the UDP/IP processing unit 320, and the like is stored in at least one of the memory 302, the storage device 303, and a register and a cache memory in the processor 301.

Further, the programs that implement the functions of the Ethernet processing unit 310, the UDP/IP processing unit 320, and the like may be stored in a portable recording medium such as a magnetic disk, a flexible disk, an optical disc, a compact disc, a Blu-ray (registered trademark) disc, or a DVD. Then, the portable recording medium that stores the programs that implement the functions of the Ethernet processing unit 310, the UDP/IP processing unit 320, and the like may be distributed.

The processor 401 is also an IC that performs processing.

The processor 401 is also a CPU, DSP, or the like.

The memory 402 is also a RAM.

The storage device 403 is also a ROM, a flash memory, an HDD, or the like.

Each of the image processing apparatus interface 404 and the servo driver interface 405 is also an electronic circuit that executes a communication process for data.

Each of the image processing apparatus interface 404 and the servo driver interface 405 is also, for example, a communication chip or an NIC.

Further, the storage device 403 also stores an OS.

Then, at least a part of the OS is executed by the processor 401.

While executing at least the part of the OS, the processor 401 executes programs that implement the functions of the movement control unit 410 and the position prediction unit 420.

By the processor 401 executing the OS, task management, memory management, file management, communication control, and the like are performed.

Further, at least one of information, data, a signal value, and a variable value that indicate results of the processes of the movement control unit 410 and the position prediction unit 420 is stored in the memory 402, the storage device 403, and a register and a cache memory in the processor 401.

Further, the programs that implement the functions of the movement control unit 410 and the position prediction unit 420 may be stored in a portable recording medium such as a magnetic disk, a flexible disk, an optical disc, a compact disc, a Blu-ray (registered trademark) disc, or a DVD. Then, the portable recording medium that stores the programs that implement the functions of the movement control unit 410 and the position prediction unit 420 may be distributed.

Further, the “unit” of at least one of the Ethernet processing unit 310, the UDP/IP processing unit 320, and the like may be read as a “circuit”, “step”, “procedure”, “process”, or “circuitry”. The “unit” of at least one of the movement control unit 410 and the position prediction unit 420 may also be read as a “circuit”, “step”, “procedure”, “process”, or “circuitry”.

Further, the image processing apparatus 300 and the motion controller 400 may be implemented by a processing circuit. The processing circuit is, for example, a logic Integrated Circuit (IC), a Gate Array (GA), an Application Specific Integrated Circuit (ASIC), or a Field-Programmable Gate Array (FPGA).

In this case, each of the Ethernet processing unit 310, the UDP/IP processing unit 320, the packet discard unit 311, and the like is implemented as a part of the processing circuit. Each of the movement control unit 410 and the position prediction unit 420 is also implemented as a part of the processing circuit.

In the present description, a superordinate concept of the processor and the processing circuit is referred to as “processing circuitry”.

That is, each of the processor and the processing circuit is a specific example of the “processing circuitry”.

### REFERENCE SIGNS LIST

1: position-setting system; 2: workpiece; 3: feature part; 4: captured image; 5: position-setting usage area; 100: movement mechanism; 110: XY stage; 120a: servomotor; 120b: servomotor; 200: camera; 300: image processing apparatus; 301: processor; 302: memory; 303: storage device; 304: network interface; 305: motion controller interface; 310: Ethernet processing unit; 311: packet discard unit; 312: filter table; 320: UDP/IP processing unit; 330: GigE Vision processing unit; 331: discard packet decision unit; 340: pattern detection unit; 341: pixel range decision unit; 400: motion controller; 401: processor; 402: memory; 403: storage device; 404: image processing apparatus interface; 405: servo driver interface; 410: movement control unit; 420: position prediction unit; 500: servo driver.

1. An image processing apparatus comprising:
processing circuitry:
to receive a plurality of payload packets that store a plurality of divided images obtained by dividing a captured image of a position-setting object subject to position setting; and
to select from the plurality of payload packets, a payload packet that stores a position-setting divided image which is a divided image subject to image processing for the position setting of the position-setting object.

2. The image processing apparatus according to claim 1, wherein
the processing circuitry discards a payload packet other than the selected payload packet among the plurality of payload packets.

3. The image processing apparatus according to claim 1, wherein
the position-setting object has a feature part,
the plurality of payload packets include a payload packet that stores a feature divided image which is a divided image that shows the feature part, and
the processing circuitry selects the payload packet that stores the feature divided image, as the payload packet that stores the position-setting divided image.

4. The image processing apparatus according to claim 3, wherein
the plurality of payload packets include a payload packet that stores a surrounding divided image which is a divided image that shows an area surrounding the feature part, and
the processing circuitry selects a payload packet that stores the surrounding divided image, as the payload packet that stores the position-setting divided image.

5. The image processing apparatus according to claim 1, wherein
the processing circuitry specifies a payload packet that stores the position-setting divided image, prior to selection of a payload packet, and
selects the specified payload packet.

6. The image processing apparatus according to claim 5, wherein
the position-setting object has a feature part,
the plurality of payload packets include a payload packet that stores a feature divided image which is a divided image that shows the feature part, and a payload packet that stores a surrounding divided image which is a divided image that shows an area surrounding the feature part, and
the processing circuitry specifies the payload packet that stores the feature divided image and the payload packet that stores the surrounding divided image, as payload packets that store the position-setting divided image.

7. The image processing apparatus according to claim 6, wherein
the processing circuitry obtains a predicted position of the feature part at a time t₁, which is predicted based on the position of the feature part at a time t₀ and the movement amount of the position-setting object between the time t₀ and the time t₁ which is a time after the time t₀, and
specifies a payload packet that stores a position-setting divided image at the time t₁, among a plurality of payload packets at the time t₁ that store a plurality of divided images at the time t₁ obtained by dividing a captured image of the position-setting object at the time t₁, using the obtained predicted position of the feature part at the time t₁.

8. The image processing apparatus according to claim 5, wherein
the processing circuitry uses a position-setting divided image at a fixed size.

9. The image processing apparatus according to claim 1, wherein
the processing circuitry receives a plurality of payload packets that store a plurality of divided images obtained by dividing the captured image in raster scan format.

10. An image processing method comprising:
receiving a plurality of payload packets that store a plurality of divided images obtained by dividing a captured image of a position-setting object subject to position setting; and
selecting from the plurality of payload packets, a payload packet that stores a position-setting divided image which is a divided image subject to image processing for the position setting of the position-setting object.

11. A non-transitory computer readable medium storing an image processing program for causing a computer to execute:
a packet reception process to receive a plurality of payload packets that store a plurality of divided images obtained by dividing a captured image of a position-setting object subject to position setting; and
a packet selection process to select from the plurality of payload packets, a payload packet that stores a position-setting divided image which is a divided image subject to image processing for the position setting of the position-setting object.
